(19) United States
(12) Patent Application Publication
(10) Pub. No.: US 2012/0183141 A1
(43) Pub. Date: Jul. 19, 2012

(54) MOBILE COMMUNICATION METHOD AND RADIO BASE STATION

(75) Inventors: Wuri Andarmawanti Hapsari, Yokosuka-shi (JP); Hideaki Takahashi, Yokohama-shi (JP); Mikio Iwamura, Minato-ku (JP); Minami Ishii, Yokohama-shi (JP); Alf Zugenmaier, Muenthen (DE)

(73) Assignee: NTT DOCOMO, INC., Tokyo (JP)

(21) Appl. No.: 13/382,063

(22) PCT Filed: Jul. 2, 2010
(86) PCT No.: PCT/JP2010/061347

§ 371 Date: Mar. 29, 2012

(30) Foreign Application Priority Data
Jul. 4, 2009 (JP) 2009-159376

(51) Int. Cl. H04W 36/00; H04W 12/06; H04K 1/00

(52) U.S. Cl. 380/272

(57) ABSTRACT

A mobile communication method according to the present invention comprising the relay node RN configured to the method comprising a step in which the relay node RN transmits the “X2-AP (UE): Handover Request” to the radio base station DeNB #2, a step in which the radio base station DeNB #2 acquires the K_eNB* and the MAC from the radio base station DeNB #1, a step in which the radio base station DeNB #2 generates the KeNB based on the acquired K_eNB* and the MAC, and a step in which the radio base station DeNB #2 generates the K_RRCint, the K_RRCenc, and the K_UPenc based on the generated KeNB.

### TECHNICAL FIELD

The present invention relates to a mobile communication method and a radio base station.

### BACKGROUND ART

In a mobile communication system employing an LTE (Long Term Evolution)-Advanced scheme which is the next version of an LTE scheme, a “relay node RN” having the same function as that of a radio base station DeNB (Donor eNB) can be connected between a mobile station UE and the radio base station DeNB.

Such an LTE-Advanced mobile communication system is so configured that an EPS bearer (Evolved Packet System Bearer) is set between the mobile station UE and a mobile switching center MME (Mobility Management Entity), a Uu radio bearer is set between the mobile station UE and the relay node RN, a Un radio bearer is set between the relay node RN and the radio base station DeNB, and an S1 bearer is set between the radio base station DeNB and the mobile switching center MME.

The current LTE-Advanced mobile communication system is configured such that the radio base station DeNB holds KeNB which is a key related to the security of the mobile station UE.

However, unlike the radio base station DeNB, the relay node RN is not a secure node, that is, unlike an installation place (a local station and the like of a telecommunication provider) of the radio base station DeNB, an installation place of the relay node RN may include various places (on a telephone pole, an outer wall of a house, and the like) according to a scenario of its use.

Therefore, it is not preferable that the KeNB, which is a key related to the security of the mobile station UE, is held by the relay node RN.

In addition, in order that the KeNB is held by the relay node RN, it is necessary to construct a secure environment in the relay node RN by using hardware and software, resulting in an increase in an apparatus cost.

In such a state, in a handover process of the mobile station UE that is communicating through the relay node RN, a method for notifying a radio base station DeNB (a handover destination) or a relay node of various types of security information has not been considered in the current LTE-Advanced mobile communication system.

### SUMMARY OF THE INVENTION

Therefore, the present invention has been achieved in view of the above-described problems, and an object thereof is to provide a mobile communication method and a radio base station by which it is possible to realize a handover process of a mobile station UE that is communicating through a relay node RN that holds no KeNB.

A gist of a first characteristic of the present invention is a mobile communication method in which a mobile station is handed over to a second radio base station from a relay node connected to a first radio base station, the mobile communication method comprises:

a step in which the relay node transmits a handover request signal to the second radio base station;

a step in which the second radio base station acquires a first parameter and a second parameter from the first radio base station;

a step in which the second radio base station generates a master key based on the acquired first parameter and second parameter; and

a step in which the second radio base station generates a key for integrity inspection of a control signal, a key for encryption of a control signal, and a key for encryption of a data signal based on the generated master key.

A gist of a second characteristic of the present invention is a mobile communication method in which a mobile station is handed over to a second relay node from a first relay node connected to a radio base station, the mobile communication method comprises, a step in which the first relay node transmits a handover request signal to the second relay node, a step in which the second relay node transmits a security information request signal to the radio base station, a step in which the radio base station generates a master key based on a first parameter and a second parameter in response to the security information request signal, a step in which the radio base station generates a key for integrity inspection of a control signal, a key for encryption of a control signal, and a key for encryption of a data signal based on the generated master key, and a step in which the radio base station notifies the second relay node of only the generated key for integrity inspection of a control signal and key for encryption of a control signal.

A gist of a third characteristic of the present invention is a mobile communication method in which a mobile station is handed over to a second radio base station from a relay node connected to a first radio base station, the mobile communication method comprises, a step in which the relay node transmits a handover request signal to the first radio base station, a step in which the first radio base station allows a first parameter and a second parameter to be included in the handover request signal, and transmits the handover request signal to the second radio base station, a step in which the second radio base station generates a master key based on the first parameter and the second parameter included in the handover request signal, and a step in which the second radio base station generates a key for integrity inspection of a control signal, a key for encryption of a control signal, and a key for encryption of a data signal based on the generated master key.

A gist of a forth characteristic of the present invention is a mobile communication method in which a mobile station is handed over to a second relay node from a first relay node connected to a radio base station, the mobile communication method comprises, a step in which the first relay node transmits a handover request signal to the radio base station, a step in which the radio base station generates a master key based on a first parameter and a second parameter in response to the handover request signal, a step in which the radio base station generates a key for integrity inspection of a control signal, a key for encryption of a control signal, and a key for encryption of a data signal based on the generated master key, and a step in which the radio base station notifies the second relay node of only the generated key for integrity inspection of a control signal and key for encryption of a control signal.

A gist of a fifth characteristic of the present invention is In a handover method in which a mobile station is handed over to a second radio base station from a relay node connected to a first radio base station, a radio base station operating as the second radio base station comprising, a function configured to receive a handover request signal from the relay node, a function configured to acquire a first parameter and a second parameter from the first radio base station in response to the received handover request signal, a function configured to generate a master key based on the acquired first parameter and second parameter, and a function configured to generate a key for integrity inspection of a control signal, a key for encryption of a control signal, and a key for encryption of a data signal based on the generated master key.

A gist of a sixth characteristic of the present invention is a handover method in which a mobile station is handed over to a second relay node from a first relay node connected to a radio base station, a radio base station operating as the radio base station comprising, a function configured to receive a security information request signal from the second relay node having received a handover request signal from the first relay node, a function configured to generate a master key based on a first parameter and a second parameter in response to the received security information request signal, a function configured to generate a key for integrity inspection of a control signal, a key for encryption of a control signal, and a key for encryption of a data signal based on the generated master key, and a function configured to notify the second relay node of only the generated key for integrity inspection of a control signal and key for encryption of a control signal.

A gist of a seventh characteristic of the present invention is a handover method in which a mobile station is handed over to a second radio base station from a relay node connected to a first radio base station, a radio base station operating as the second radio base station comprising, a function configured to receive a handover request signal from the first radio base station having received the handover request signal from the relay node, a function configured to generate a master key based on a first parameter and a second parameter included in the received handover request signal, and a function configured to generate a key for integrity inspection of a control signal, a key for encryption of a control signal, and a key for encryption of a data signal based on the generated master key.

A gist of a eighth characteristic of the present invention is a handover method in which a mobile station is handed over to a second relay node from a first relay node connected to a radio base station, a radio base station operating as the radio base station comprising a function configured to receive a handover request signal from the first relay node, a function configured to generate a master key based on a first parameter and a second parameter in response to the received handover request signal, a function configured to generate a key for integrity inspection of a control signal, a key for encryption of a control signal, and a key for encryption of a data signal based on the generated master key, and a function configured to notify the second relay node of only the generated key for integrity inspection of a control signal and key for encryption of a control signal.

As described above, according to the present invention, it is possible to provide a mobile communication method and a radio base station by which it is possible to realize a handover process of a mobile station UE that is communicating through a relay node RN that holds no KeNB.

### BRIEF DESCRIPTION OF THE DRAWINGS

FIG. 1 is an entire configuration diagram of a mobile communication system according to a first embodiment of the present invention.

FIG. 2 is an entire configuration diagram of the mobile communication system according to the first embodiment of the present invention.

FIG. 3 is a diagram illustrating a protocol stack of the mobile communication system according to the first embodiment of the present invention.

FIG. 4 is a sequence diagram illustrating an operation of the mobile communication system according to the first embodiment of the present invention.

FIG. 5 is a sequence diagram illustrating an operation of the mobile communication system according to the first embodiment of the present invention.

FIG. 6 is a diagram illustrating a protocol stack of a mobile communication system according to a second embodiment of the present invention.

FIG. 7 is a sequence diagram illustrating an operation of the mobile communication system according to the second embodiment of the present invention.

FIG. 8 is a sequence diagram illustrating an operation of the mobile communication system according to the second embodiment of the present invention.

FIG. 9 is a diagram illustrating a protocol stack of a mobile communication system according to a third embodiment of the present invention.

FIG. 10 is a sequence diagram illustrating an operation of a mobile communication system according to the third embodiment of the present invention.

FIG. 11 is a sequence diagram illustrating an operation of the mobile communication system according to the third embodiment of the present invention.

FIG. 12 is a diagram illustrating a protocol stack of a mobile communication system according to a fourth embodiment of the present invention.

FIG. 13 is a sequence diagram illustrating an operation of the mobile communication system according to the fourth embodiment of the present invention.

FIG. 14 is a sequence diagram illustrating an operation of the mobile communication system according to the fourth embodiment of the present invention.

### DETAILED DESCRIPTION

### Mobile Communication System according to First Embodiment of Present Invention

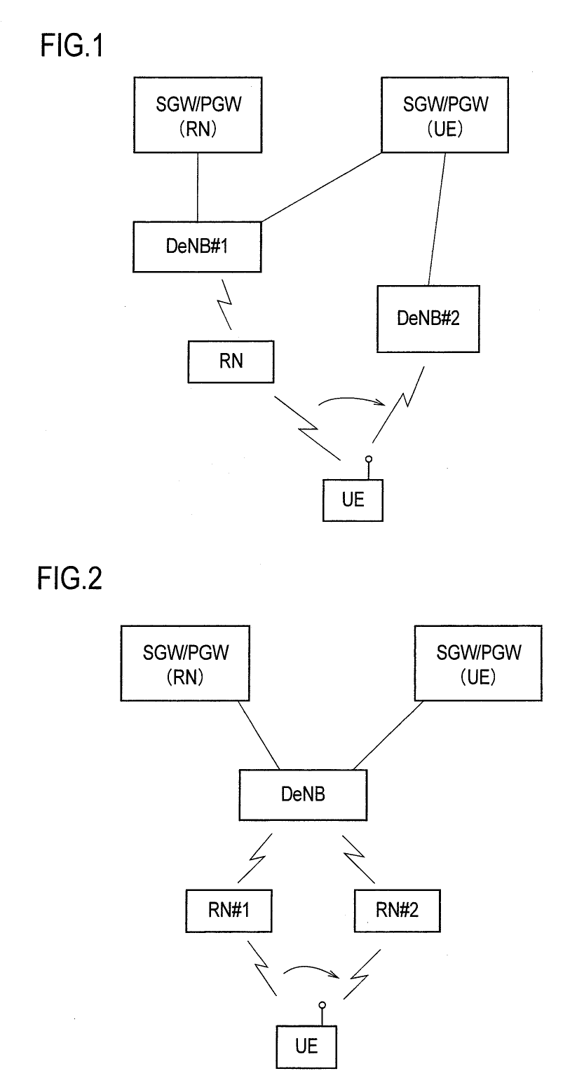

With reference to FIG. 1 to FIG. 5, a mobile communication system according to a first embodiment of the present invention will be described.

The mobile communication system according to the present embodiment is an LTE-Advanced mobile communication system, and includes a mobile station UE, a relay node RN, a base station DeNB, a gateway device SGW (Serving Gateway)/PGW (PDN Gateway) for the relay node RN, a mobile switching center MME, and the like.

Hereinafter, the present embodiment will describe a case 1 (refer to FIG. 1) where the mobile station UE is handed over to a radio base station DeNB #2 (a second radio base station) from a relay node RN connected to a radio base station DeNB #1 (a first radio base station), and a case 2 (refer to FIG. 2) where the mobile station UE is handed over to a relay node RN #2 (a second relay node) from a relay node RN #1 (a first relay node) connected to a radio base station DeNB.

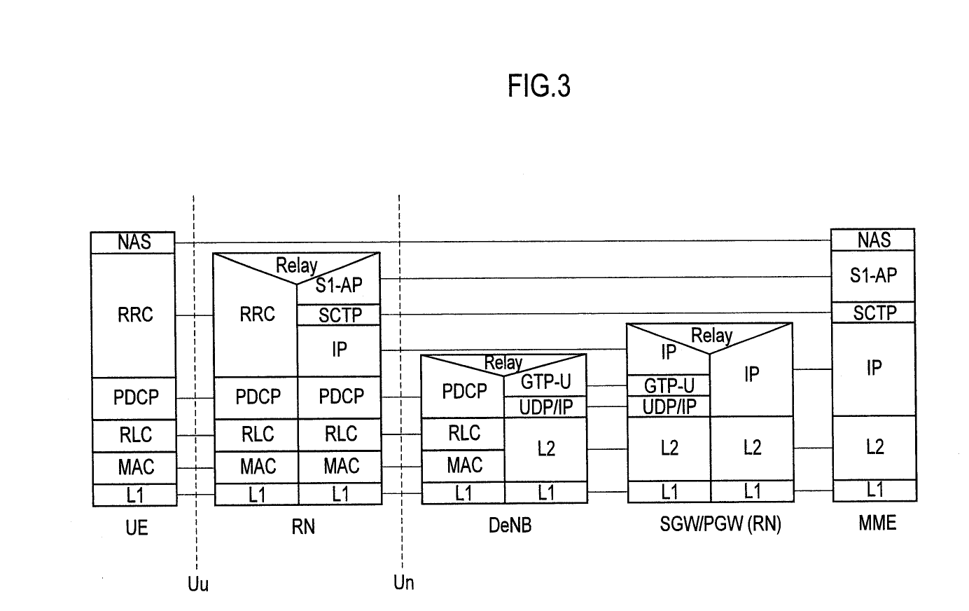

FIG. 3 illustrates a protocol stack of the mobile communication system according to the present embodiment.

As illustrated in FIG. 3, the mobile station UE includes a physical layer (L1) function, an MAC (Media Access Control) layer function, an RLC (Radio Link Control) layer function, a PDCP (Packet Data Convergence Protocol) layer function, an RRC (Radio Resource Control) layer function, and a NAS layer function.

The relay node RN, as the function of a Uu interface, includes the physical layer (L1) function, the MAC layer function, the RLC layer function, the PDCP layer function, and the RRC layer function.

Furthermore, the relay node RN, as the function of a Un interface, includes the physical layer (L1) function, the MAC layer function, the RLC layer function, the PDCP layer function, an IP (Internet Protocol) layer function, an SCTP (Stream Control Transmission Protocol) layer function, and an S1-AP layer function.

The radio base station DeNB, as the function of the Un interface, includes the physical layer (L1) function, the MAC layer function, the RLC layer function, and the PDCP layer function.

Furthermore, the radio base station DeNB, as the function of the gateway device SGW/PGW-side for the relay node RN, includes the physical layer (L1) function, an L2 function, a UDP (User Datagram Protocol)/IP layer function, and a GTP-U (GPRS Tunneling Protocol-U plane) layer function.

The gateway device SGW/PGW for the relay node RN, as the function of the radio base station DeNB-side, includes the physical layer (L1) function, the L2 function, the UDP/IP layer function, the GTP-U layer function, and the IP layer function.

Furthermore, the gateway device SGW/PGW for the relay node RN, as the function of the mobile switching center MME-side, includes the physical layer (L1) function, the L2 function, the IP layer function, the SCTP layer function, the S1-AP layer function, and the NAS layer function. Furthermore, the mobile switching center MME includes the physical layer (L1) function, the L2 function, and the IP layer function.

Here, an S1-AP is configured to be terminated between the S1-AP layer function of the relay node RN and the S1-AP layer function of the mobile switching center MME.

Furthermore, a PDCP (RRC) is configured to be terminated between the PDCP (RRC) layer function of the relay node RN and the PDCP (RRC) layer function of the radio base station DeNB.

In addition, in the mobile communication system according to the present embodiment, the radio base station DeNB is configured to perform processing and management with respect to security information (UE AS Security Context) for a U plane (a data signal), and the relay node RN is configured to perform processing and management with respect to security information (UE AS Security Context) for a C plane (a control signal).

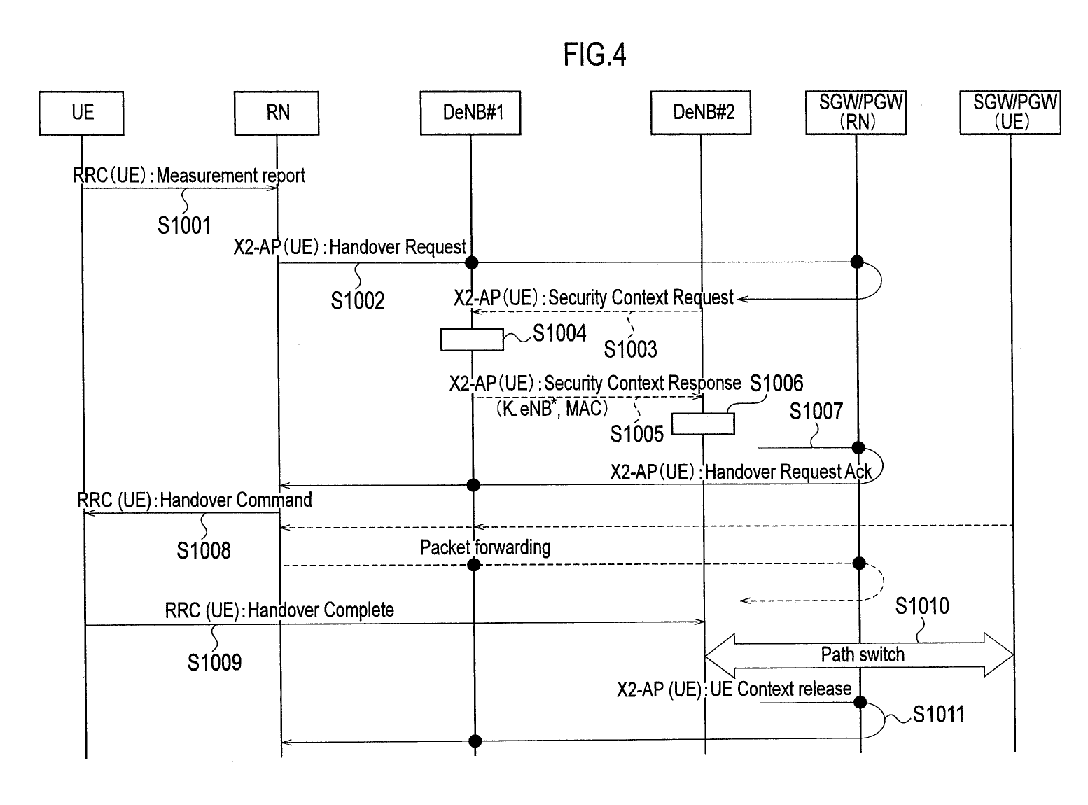

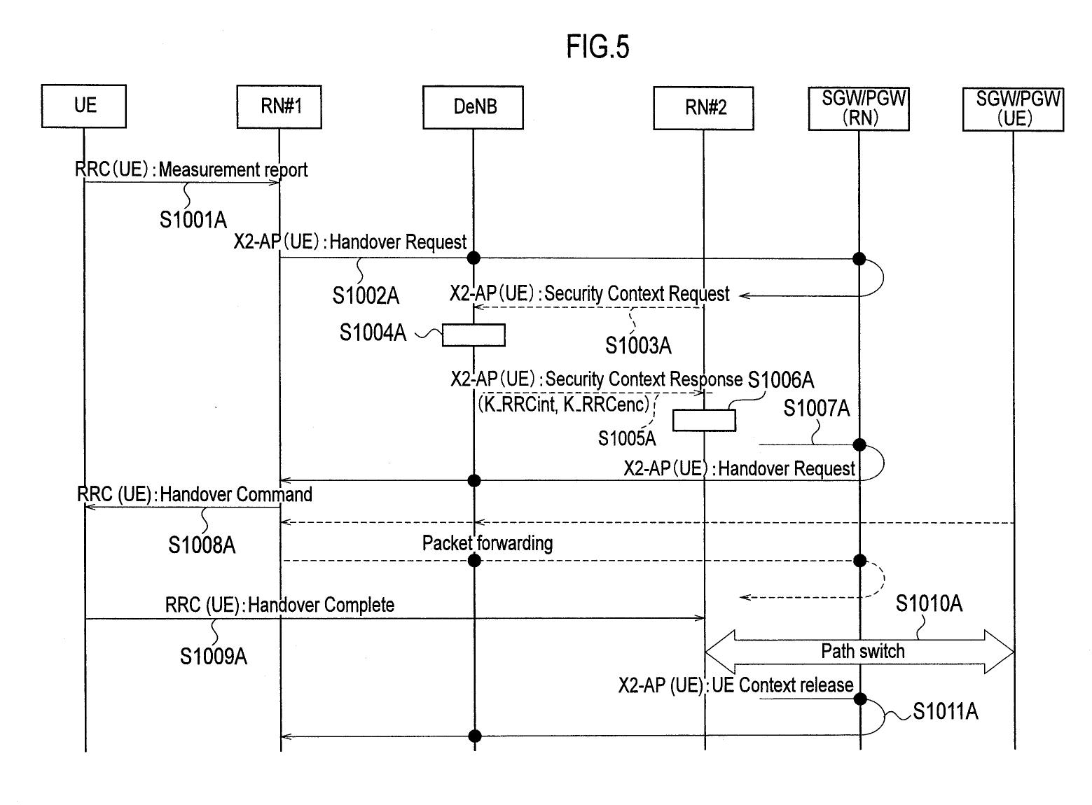

Hereinafter, with reference to FIG. 4 and FIG. 5, a handover method of the mobile station UE in the mobile communication system according to the present embodiment will be described.

Firstly, with reference to FIG. 4, the operation of the mobile communication system according to the present embodiment in the above-mentioned case 1 will be described.

As illustrated in FIG. 4, in step S1001, when predetermined conditions are satisfied, the mobile station UE transmits an “RRC (UE): Measurement report (measurement report)” to the relay node RN.

When it is determined to hand over the mobile station UE to the radio base station DeNB #2, the relay node RN transmits an “X2-AP (UE): Handover Request (a handover request signal)” to the radio base station DeNB #2 by way of the radio base station DeNB #1 and the gateway device SGW/PGW for the relay node RN in step S1002.

Here, it is not possible for the radio base station DeNB #1 to recognize the “X2-AP (UE): Handover Request”.

In step S1003, the radio base station DeNB #2 transmits an “X2-AP (UE): Security Context Request (a security information request signal)” to the radio base station DeNB #1 in response to the received “X2-AP (UE): Handover Request”.

The radio base station DeNB #1 extracts a K_eNB* (a first parameter) and MAC (Message Authentication Code) (a second parameter) in response to the received “X2-AP (UE): Security Context Request” in step S1004, and transmits an “X2-AP (UE): Security Context Response (a security information response signal)” including the extracted K_eNB* and MAC to the radio base station DeNB #2 in step S1005.

In step S1006, the radio base station DeNB #2 generates KeNB (a master key) based on the K_eNB* and the MAC included in the “X2-AP (UE): Security Context Response”, and generates and holds K_RRCint, K_RRCenc, and K_UPenc based on the KeNB.

Here, the KeNB is a master key which is generated used using K_ASME and used in order to generate the K_RRCint, the K_RRCenc, the K_UPenc and the like.

The K_RRCint is a key (an AS layer) for integrity inspection of a C plane (a control signal), the K_RRCenc is a key (an AS layer) for encryption of the C plane (the control signal), and the K_UPenc is a key for encryption of a U plane (a data signal).

In step S1007, the radio base station DeNB #2 transmits an “X2-AP (UE): Handover Request Ack” to the relay node RN by way of the gateway device SGW/PGW for the relay node RN and the radio base station DeNB #1.

Here, it is not possible for the radio base station DeNB #1 to recognize the “X2-AP (UE): Handover Request Ack”.

In step S1008, the relay node RN transmits an “RRC (UE): Handover Command (a handover command signal)” to the mobile station UE.

In step S1009, the mobile station UE transmits an “RRC (UE): Handover Complete (a handover completion signal)” to the radio base station DeNB #2.

A “Path switch procedure” is performed between the radio base station DeNB #2 and a gateway device SGW/PGW for the mobile station UE in step S1010, and as a result, a downlink data signal is transferred to the radio base station DeNB #2, other than the relay node RN, from the gateway device SGW/PGW for the mobile station UE.

In step S1011, the radio base station DeNB #2 transmits an “X2-AP (UE): UE Context release” to the relay node RN by way of the gateway device SGW/PGW for the relay node RN and the radio base station DeNB #1.

Secondly, with reference to FIG. 5, the operation of the mobile communication system according to the present embodiment in the above-mentioned case 2 will be described.

As illustrated in FIG. 5, in step S1001A, when predetermined conditions are satisfied, the mobile station UE transmits an “RRC (UE): Measurement report” to the relay node RN #1.

When it is determined to hand over the mobile station UE to the relay node RN #2, the relay node RN #1 transmits an “X2-AP (UE): Handover Request” to the relay node RN #2 by way of the radio base station DeNB and the gateway device SGW/PGW for the relay node RN in step S1002A.

Here, it is not possible for the radio base station DeNB to recognize the “X2-AP (UE): Handover Request”.

In step S1003A, the relay node RN #2 transmits an “X2-AP (UE): Security Context Request” to the radio base station DeNB in response to the received “X2-AP (UE): Handover Request”.

In step S1004A, the radio base station DeNB extracts K_eNB* and MAC in response to the received “X2-AP (UE): Security Context Request”, generates KeNB based on the K_eNB* and the MAC, and generates K_RRCint, K_RRCenc, and K_UPenc based on the KeNB.

In step S1005A, the radio base station DeNB transmits an “X2-AP (UE): Security Context Response” including the generated K_RRCint and K_RRCenc and not including the generated K_UPenc to the relay node RN #2.

In step S1006A, the relay node RN #2 holds the K_RRCint and the K_RRCenc included in the “X2-AP (UE): Security Context Response”.

In step S1007A, the relay node RN #2 transmits an “X2-AP (UE): Handover Request Ack” to the relay node RN #1 by way of the gateway device SGW/PGW for the relay node RN and the radio base station DeNB.

Here, it is not possible for the radio base station DeNB to recognize the “X2-AP (UE): Handover Request Ack”.

In step S1008A, the relay node RN #1 transmits an “RRC (UE): Handover Command” to the mobile station UE.

In step S1009A, the mobile station UE transmits an “RRC (UE): Handover Complete” to the relay node RN #2.

A “Path switch procedure” is performed between the relay node RN #2 and the gateway device SGW/PGW for the mobile station UE in step S1010A, and as a result, a downlink data signal is transferred to the relay node RN #2, other than the relay node RN #1, from the gateway device SGW/PGW for the mobile station UE.

In step S1011A, the relay node RN #2 transmits an “X2-AP (UE): UE Context release” to the relay node RN #1 by way of the gateway device SGW/PGW for the relay node RN and the radio base station DeNB.

In accordance with the mobile communication system according to the first embodiment of the present invention, in the handover process of the mobile station UE, the radio base station DeNB #1 can notify the radio base station DeNB #2 of the security information (the K_eNB* and the MAC, or the K_RRCint and the K_RRCenc) in response to the “X2-AP (UE): Security Context Request” from the radio base station DeNB #2, so that it is possible to realize the handover process of the mobile station UE that is communicating via the relay node RN that holds no KeNB.

The characteristics of the present embodiment as described above may be expressed as follows.

A first characteristic of the present embodiment is summarized as a mobile communication method, more particularly, a handover method in which the mobile station UE is handed over to the radio base station DeNB #2 (the second radio base station) from the relay node RN connected to the radio base station DeNB #1 (the first radio base station), the method comprising: a step in which the relay node RN transmits the “X2-AP (UE): Handover Request (the handover request signal)” to the radio base station DeNB #2; a step in which the radio base station DeNB #2 acquires the K_eNB* (the first parameter) and the MAC (the second parameter) from the radio base station DeNB #1; a step in which the radio base station DeNB #2 generates the KeNB (the master key) based on the acquired K_eNB* and MAC; and a step in which the radio base station DeNB #2 generates the K_RRCint (the key for integrity inspection of a control signal), the K_RRCenc (the key for encryption of a control signal), and the K_UPenc (the key for encryption of a data signal) based on the generated KeNB.

A second characteristic of the present embodiment is summarized as a mobile communication method, more particularly, a handover method in which the mobile station UE is handed over to the relay node RN #2 (the second relay node RN) from the relay node RN #1 (the first relay node RN) connected to the radio base station DeNB, the method comprising: a step in which the relay node RN #1 transmits the “X2-AP (UE): Handover Request” to the relay node RN #2; a step in which the relay node RN #2 transmits the “X2-AP (UE): Security Context Request (the security information request signal) to the radio base station DeNB; a step in which the radio base station DeNB generates the KeNB based on the K_eNB* and the MAC in response to the “X2-AP (UE): Security Context Request”; a step in which the radio base station DeNB generates the K_RRCint, the K_RRCenc, and the K_UPenc based on the generated KeNB; and a step in which the radio base station DeNB notifies the relay node RN #2 of only the generated K_RRCint and K_RRCenc.

A third characteristic of the present embodiment is summarized as, in a handover method in which the mobile station UE is handed over to the radio base station DeNB #2 from the relay node RN connected to the radio base station DeNB #1, a radio base station DeNB operating as the radio base station DeNB #2 comprising: a function configured to receive the “X2-AP (UE): Handover Request” from the relay node RN by way of the gateway device SGW/PGW for the relay node RN; a function configured to acquire the K_eNB* and the MAC from the radio base station DeNB #1 in response to the received “X2-AP (UE): Handover Request”; a function configured to generate the KeNB based on the acquired K_eNB* and MAC; and a function configured to generate the K_RRCint, the K_RRCenc, and the K_UPenc based on the generated KeNB.

A fourth characteristic of the present embodiment is summarized as, in a handover method in which the mobile station UE is handed over to the relay node RN #2 from the relay node RN #1 connected to the radio base station DeNB, a radio base station DeNB comprising: a function configured to receive the “X2-AP (UE): Security Context Request” from the relay node RN #2 having received the “X2-AP (UE): Handover Request” from the relay node RN #1 by way of the gateway device SGW/PGW for the relay node RN #1; a function configured to generate the KeNB based on the K_eNB* and the MAC in response to the received “X2-AP (UE): Security Context Request”; a function configured to generate the K_RRCint, the K_RRCenc, and the K_UPenc based on the generated KeNB; and a function configured to notify the relay node RN #2 of only the generated K_RRCint and K_RRCenc.

### Mobile Communication System according to Second Embodiment of Present Invention

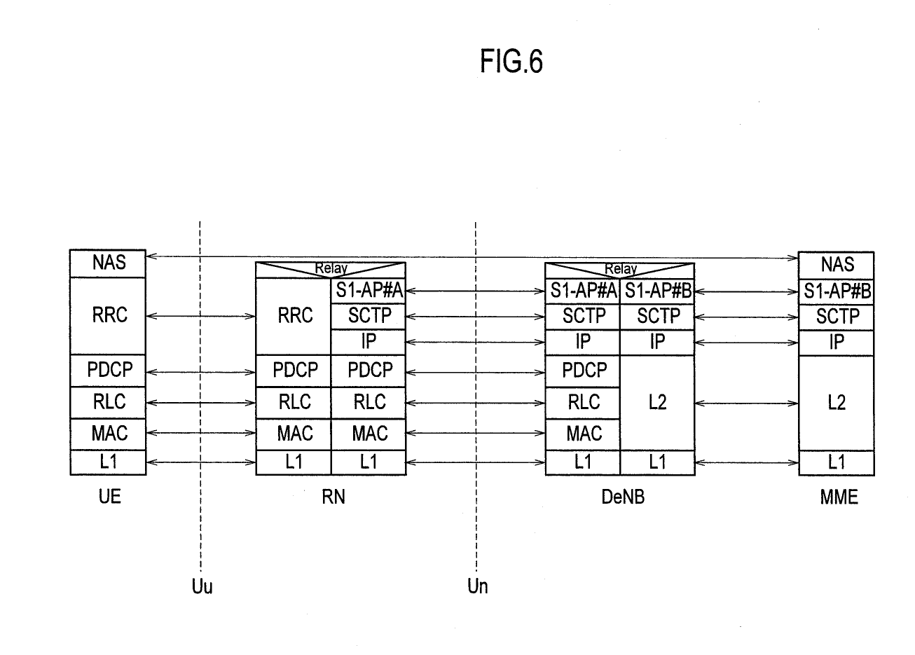

With reference to FIG. 6 to FIG. 8, a mobile communication system according to a second embodiment of the present invention will be described. Hereinafter, the mobile communication system according to the second embodiment of the present invention will be described while focusing on the difference from the mobile communication system according to the above-mentioned first embodiment.

As illustrated in FIG. 6, the radio base station DeNB, as the function of a Un interface, includes the physical layer (L1) function, the MAC layer function, the RLC layer function, the PDCP layer function, the IP layer function, the SCTP layer function, and the S1-AP layer function.

Here, the S1-AP layer function may be an S1-AP layer function obtained by repairing an S1-AP layer function defined in the 3GPP Release.8, and may be a separate S1-AP layer function.

Furthermore, the radio base station DeNB, as the function of a mobile switching center MME-side, includes the physical layer (L1) function, an L2 function, the IP layer function, the SCTP layer function, and the S1-AP layer function.

Here, an S1-AP#A is configured to be terminated between the S1-AP layer function of the relay node RN and the S1-AP layer function of the radio base station DeNB.

Furthermore, an S1-AP#B is configured to be terminated between the S1-AP layer function of the relay node RN and the S1-AP layer function of the mobile switching center MME.

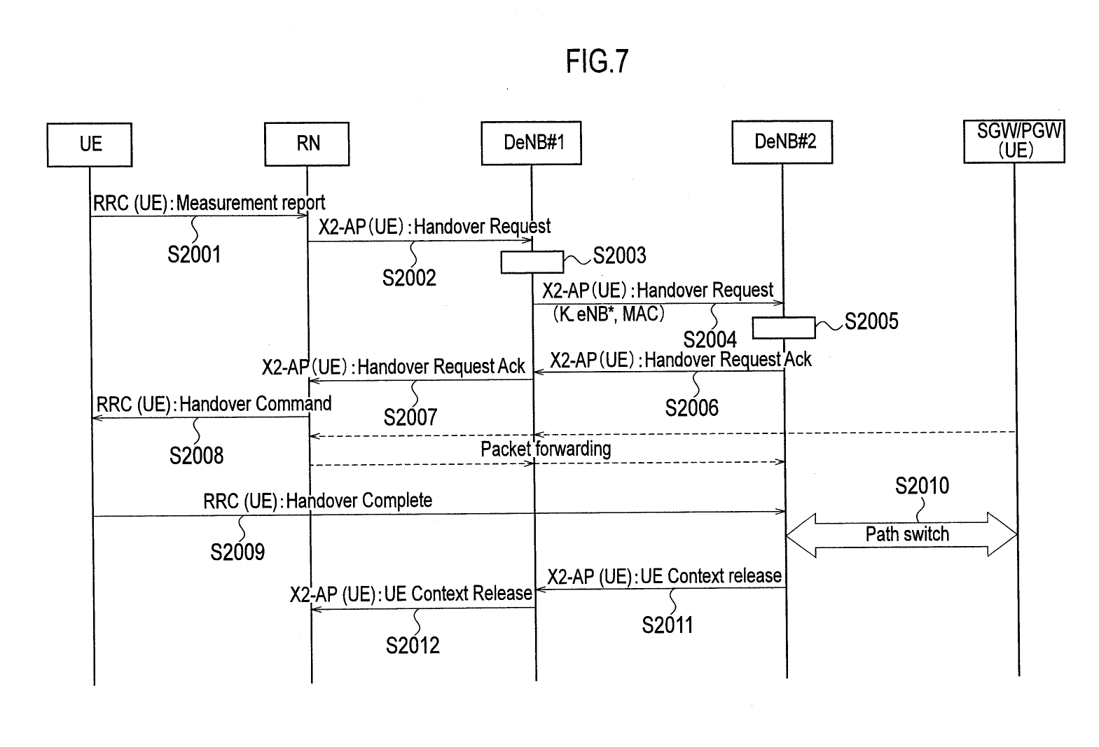

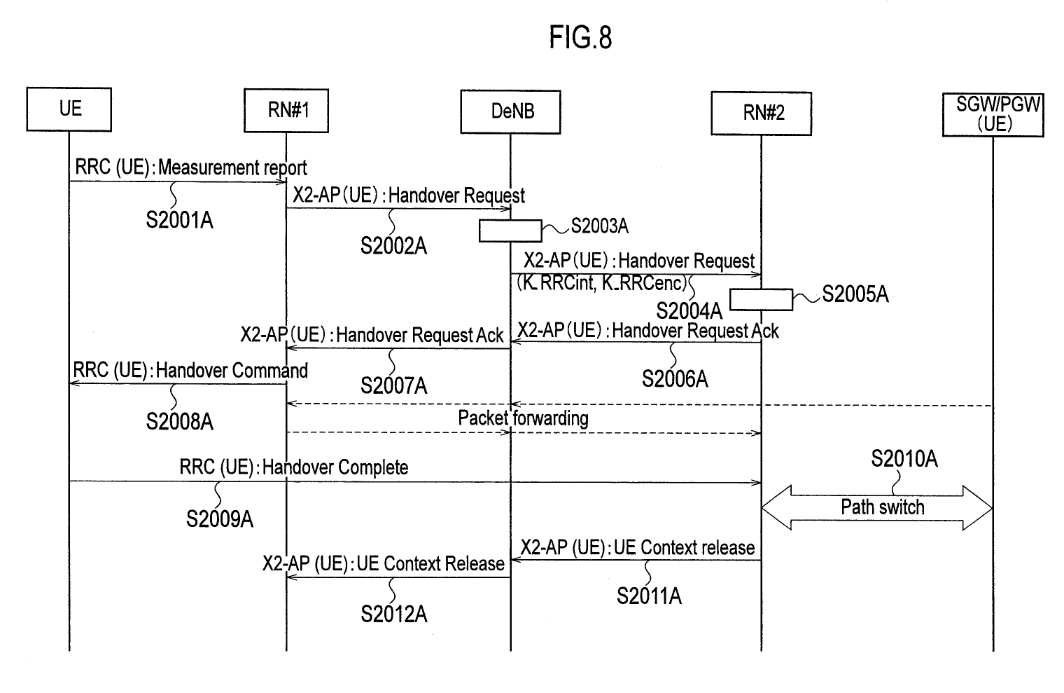

Hereinafter, with reference to FIG. 7 and FIG. 8, a handover method of the mobile station UE in the mobile communication system according to the present embodiment will be described.

Firstly, with reference to FIG. 7, the operation of the mobile communication system according to the present embodiment in the above-mentioned case 1 will be described.

As illustrated in FIG. 7, in step S2001, when predetermined conditions are satisfied, the mobile station UE transmits an “RRC (UE): Measurement report” to the relay node RN.

When it is determined to hand over the mobile station UE to the radio base station DeNB #2, the relay node RN transmits an “X2-AP (UE): Handover Request” to the radio base station DeNB #1 in step S2002.

The radio base station DeNB #1 extracts K_eNB* and MAC in response to the received “X2-AP (UE): Handover Request” in step S2003, and transmits the “X2-AP (UE): Handover Request” including the extracted K_eNB* and MAC to the radio base station DeNB #2 in step S2004.

In step S2005, the radio base station DeNB #2 generates KeNB based on the K_eNB* and the MAC included in the “X2-AP (UE): Handover Request”, and generates and holds K_RRCint, K_RRCenc, and K_UPenc based on the KeNB.

In step S2006, the radio base station DeNB #2 transmits an “X2-AP (UE): Handover Request Ack” to the radio base station DeNB #1.

In step S2007, the radio base station DeNB #1 transmits the “X2-AP (UE): Handover Request Ack” to the relay node RN.

In step S2008, the relay node RN transmits an “RRC (UE): Handover Command” to the mobile station UE.

In step S2009, the mobile station UE transmits an “RRC (UE): Handover Complete” to the radio base station DeNB #2.

A “Path switch procedure” is performed between the radio base station DeNB #2 and a gateway device SGW/PGW for the mobile station UE in step S2010, and as a result, a downlink data signal is transferred to the radio base station DeNB #2, other than the relay node RN, from the gateway device SGW/PGW for the mobile station UE.

In step S2011, the radio base station DeNB #2 transmits an “X2-AP (UE): UE Context release” to the radio base station DeNB #1.

In step S2012, the radio base station DeNB #1 transmits the “X2-AP (UE): UE Context release” to the relay node RN.

Secondly, with reference to FIG. 8, the operation of the mobile communication system according to the present embodiment in the above-mentioned case 2 will be described.

As illustrated in FIG. 8, in step S2001A, when predetermined conditions are satisfied, the mobile station UE transmits an “RRC (UE): Measurement report” to the relay node RN #1.

When it is determined to hand over the mobile station UE to the relay node RN #2, the relay node RN #1 transmits an “X2-AP (UE): Handover Request” to the radio base station DeNB in step S2002A.

In step S2003A, the radio base station DeNB extracts K_eNB* and MAC in response to the received “X2-AP (UE): Handover Request”, generates K_eNB based on the K_eNB* and the MAC, and generates K_RRCint, K_RRCenc, and K_UPenc based on the KeNB.

In step S2004A, the radio base station DeNB transmits the “X2-AP (UE): Handover Request” including the generated K_RRCint and K_RRCenc and not including the generated K_UPenc to the relay node RN #2.

In step S2005A, the relay node RN #2 holds the K_RRCint and the K_RRCenc included in the “X2-AP (UE): Handover Request”.

In step S2006A, the relay node RN #2 transmits an “X2-AP (UE): Handover Request Ack” to the radio base station DeNB.

In step S2007A, the radio base station DeNB transmits the “X2-AP (UE): Handover Request Ack” to the relay node RN #1.

In step S2008A, the relay node RN #1 transmits an “RRC (UE): Handover Command” to the mobile station UE.

In step S2009A, the mobile station UE transmits an “RRC (UE): Handover Complete” to the relay node RN #2.

A “Path switch procedure” is performed between the relay node RN #2 and the gateway device SGW/PGW for the mobile station UE in step S2010A, and as a result, downlink data signal is transferred to the relay node RN #2, other than the relay node RN #1, from the gateway device SGW/PGW for the mobile station UE.

In step S2011A, the relay node RN #2 transmits an “X2-AP (UE): UE Context release” to the radio base station DeNB.

In step S2012A, the radio base station DeNB transmits the “X2-AP (UE): UE Context release” to the relay node RN #1.

In accordance with the mobile communication system according to the second embodiment of the present invention, in the handover process of the mobile station UE, the radio base station DeNB can notify the relay node RN #2 of the security information (the K_eNB* and the MAC, or the K_RRCint and the K_RRCenc) in response to the “X2-AP (UE): Handover Request” received from the relay node RN #1, so that it is possible to realize the handover process of the mobile station UE that is communicating via the relay node RN that holds no KeNB.

The characteristics of the present embodiment as described above may be expressed as follows.

A first characteristic of the present embodiment is summarized as a mobile communication method, more particularly, a handover method in which the mobile station UE is handed over to the radio base station DeNB #2 from the relay node RN connected to the radio base station DeNB #1, the method comprising: a step in which the relay node RN transmits the “X2-AP (UE): Handover Request” to the radio base station DeNB #1; a step in which the radio base station DeNB #1 allows the K_eNB* and the MAC to be included in the “X2-AP (UE): Handover Request” and transmits the “X2-AP (UE): Handover Request” to the radio base station DeNB #2; a step in which the radio base station DeNB #2 generates the KeNB based on the K_eNB* and the MAC included in the “X2-AP (UE): Handover Request”; and a step in which the radio base station DeNB #2 generates the K_RRCint, the K_RRCenc, and the K_UPenc based on the generated KeNB.

A second characteristic of the present embodiment is summarized as a mobile communication method, more particularly, a handover method in which the mobile station UE is handed over to the relay node RN #2 from the relay node RN #1 connected to the radio base station DeNB, the method comprising: a step in which the relay node RN #1 transmits the “X2-AP (UE): Handover Request” to the radio base station DeNB; a step in which the radio base station DeNB generates the KeNB based on the K_eNB* and the MAC in response to the “X2-AP (UE): Handover Request”; a step in which the radio base station DeNB generates the K_RRCint, the K_RRCenc, and the K_UPenc based on the generated KeNB; and a step in which the radio base station DeNB notifies the relay node RN #2 of only the generated K_RRCint and K_RRCenc.

A third characteristic of the present embodiment is summarized as, in a handover method in which the mobile station UE is handed over to the radio base station DeNB #2 from the relay node RN connected to the radio base station DeNB #1, a radio base station DeNB operating as the radio base station DeNB #2 comprising: a function configured to receive the “X2-AP (UE): Handover Request” from the radio base station DeNB #1 having received the “X2-AP (UE): Handover Request” from the relay node RN; a function configured to generate the KeNB based on the K_eNB* and the MAC included in received the “X2-AP (UE): Handover Request”; and a function configured to generate the K_RRCint, the K_RRCenc, and the K_UPenc based on the generated KeNB.

A fourth characteristic of the present embodiment is summarized as, in a handover method in which the mobile station UE is handed over to the relay node RN #2 from the relay node RN #1 connected to the radio base station DeNB, a radio base station DeNB comprising: a function configured to receive the “X2-AP (UE): Handover Request” from the relay node RN #1; a function configured to generate the KeNB based on the K_eNB* and the MAC in response to the received “X2-AP (UE): Handover Request”; a function configured to generate the K_RRCint, the K_RRCenc, and the K_UPenc based on the generated KeNB; and a function configured to notify the relay node RN #2 of only the generated K_RRCint and K_RRCenc.

### Mobile Communication System according to Third Embodiment of Present Invention

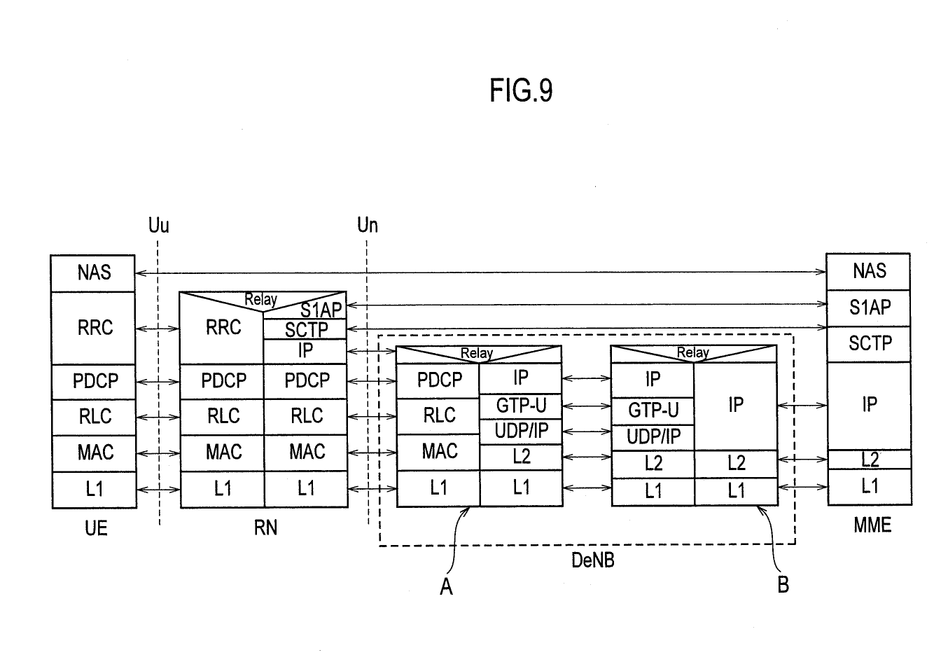

With reference to FIG. 9 to FIG. 11, a mobile communication system according to a third embodiment of the present invention will be described.

Hereinafter, the mobile communication system according to the third embodiment of the present invention will be described while focusing on the difference from the mobile communication system according to the above-mentioned first embodiment.

In the mobile communication system according to the present embodiment, as illustrated in FIG. 9, the radio base station DeNB is configured to have the function of the gateway device SGW/PGW for the relay node RN illustrated in FIG. 3.

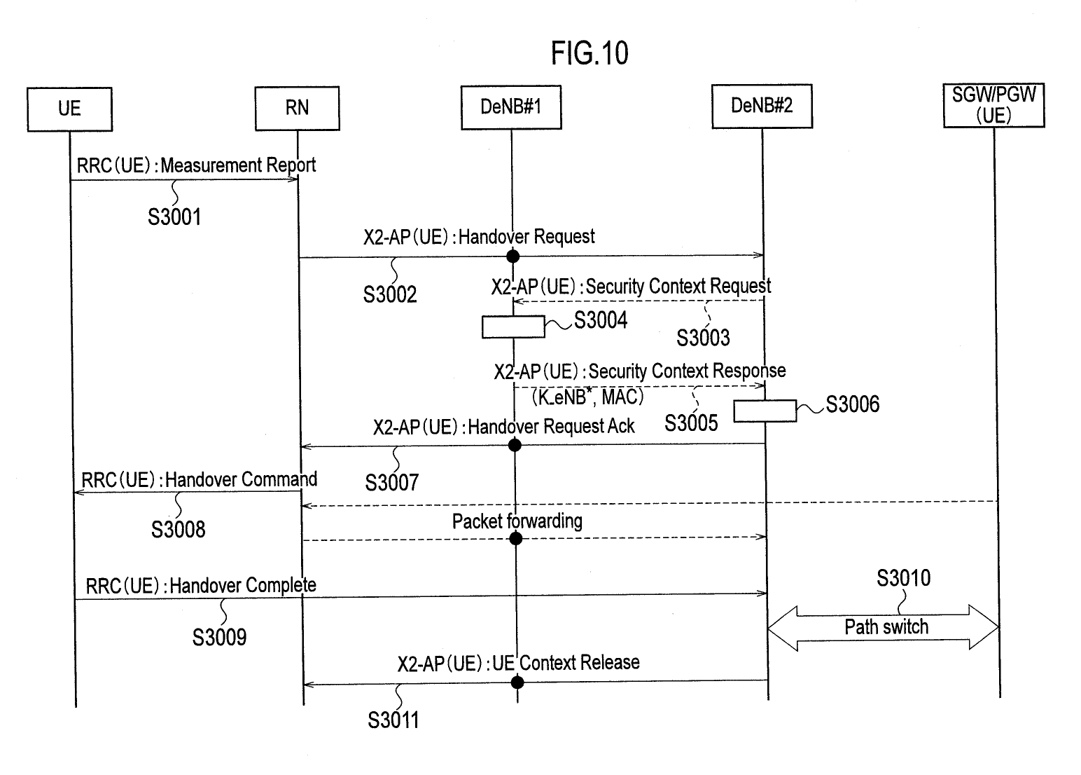

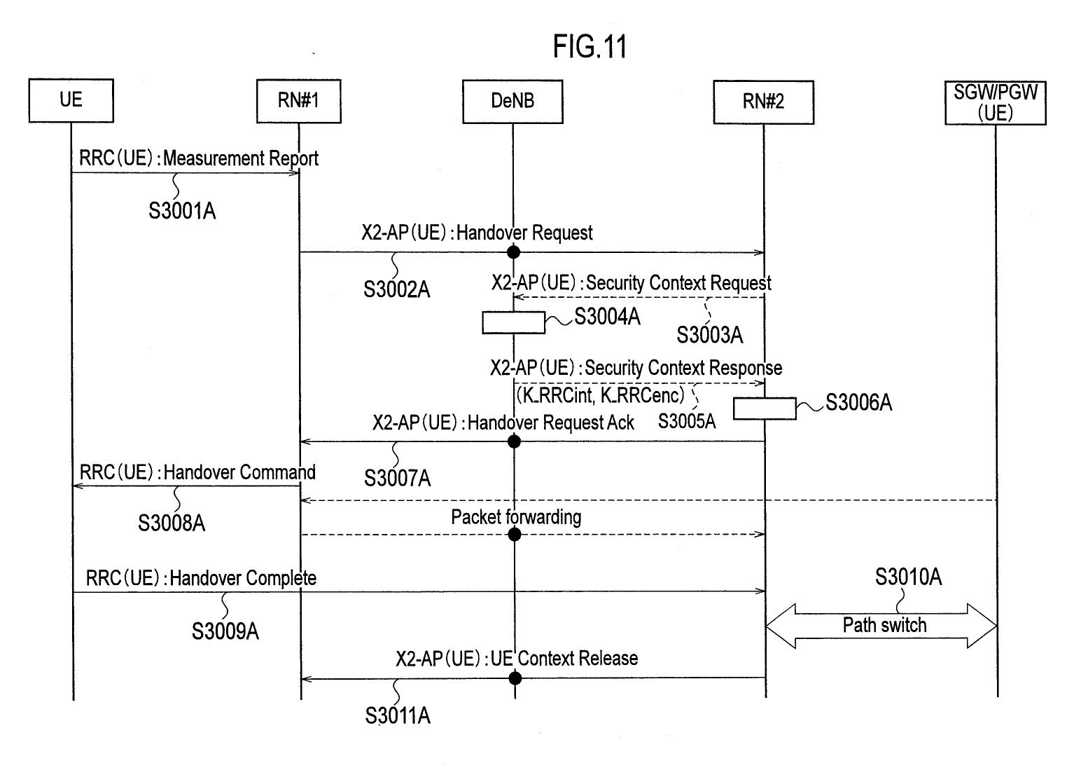

Hereinafter, with reference to FIG. 10 and FIG. 11, a handover method of the mobile station UE in the mobile communication system according to the present embodiment will be described.

Firstly, with reference to FIG. 10, the operation of the mobile communication system according to the present embodiment in the above-mentioned case 1 will be described.

As illustrated in FIG. 10, in step S3001, when predetermined conditions are satisfied, the mobile station UE transmits an “RRC (UE): Measurement report” to the relay node RN.

When it is determined to hand over the mobile station UE to the radio base station DeNB #2, the relay node RN transmits an “X2-AP (UE): Handover Request” to the radio base station DeNB #2 by way of the radio base station DeNB #1 in step S3002.

Here, it is not possible for the radio base station DeNB #1 to recognize the “X2-AP (UE): Handover Request”.

In step S3003, the radio base station DeNB #2 transmits an “X2-AP (UE): Security Context Request” to the radio base station DeNB #1 in response to the received “X2-AP (UE): Handover Request”.

The radio base station DeNB #1 extracts K_eNB* and MAC in response to the received “X2-AP (UE): Security Context Request” in step S3004, and transmits an “X2-AP (UE): Security Context Response” including the extracted K_eNB* and MAC to the radio base station DeNB #2 in step S3005.

In step S3006, the radio base station DeNB #2 generates KeNB based on the K_eNB* and the MAC included in the “X2-AP (UE): Security Context Response”, and generates and holds K_RRCint, K_RRCenc, and K_UPenc based on the KeNB.

In step S3007, the radio base station DeNB #2 transmits an “X2-AP (UE): Handover Request Ack” to the relay node RN by way of the radio base station DeNB #1.

Here, it is not possible for the radio base station DeNB #1 to recognize the “X2-AP (UE): Handover Request Ack”.

In step S3008, the relay node RN transmits an “RRC (UE): Handover Command” to the mobile station UE.

In step S3009, the mobile station UE transmits an “RRC (UE): Handover Complete” to the radio base station DeNB #2.

A “Path switch procedure” is performed between the radio base station DeNB #2 and a gateway device SGW/PGW for the mobile station UE in step S3010, and as a result, a downlink data signal is transferred to the radio base station DeNB #2, other than the relay node RN, from the gateway device SGW/PGW for the mobile station UE.

In step S3011, the radio base station DeNB #2 transmits an “X2-AP (UE): UE Context release” to the relay node RN via the radio base station DeNB #1.

Secondly, with reference to FIG. 11, the operation of the mobile communication system according to the present embodiment in the above-mentioned case 2 will be described.

As illustrated in FIG. 11, in step S3001A, when predetermined conditions are satisfied, the mobile station UE transmits an “RRC (UE): Measurement report” to the relay node RN #1.

When it is determined to hand over the mobile station UE to the relay node RN #2, the relay node RN #1 transmits an “X2-AP (UE): Handover Request” to the relay node RN #2 by way of the radio base station DeNB in step S3002A.

Here, it is not possible for the radio base station DeNB to recognize the “X2-AP (UE): Handover Request”.

In step S3003A, the relay node RN #2 transmits an “X2-AP (UE): Security Context Request” to the radio base station DeNB in response to the received “X2-AP (UE): Handover Request”.

In step S3004A, the radio base station DeNB extracts K_eNB* and MAC in response to the received “X2-AP (UE): Security Context Request”, generates K_eNB based on the K_eNB* and the MAC, and generates K_RRCint, K_RRCenc, and K_UPenc based on the KeNB.

In step S3005A, the radio base station DeNB transmits an “X2-AP (UE): Security Context Response” including the generated K_RRCint and K_RRCenc and not including the generated K_UPenc to the relay node RN #2.

In step S3006A, the relay node RN #2 holds the K_RRCint and the K_RRCenc included in the “X2-AP (UE): Security Context Response”.

In step S3007A, the relay node RN #2 transmits an “X2-AP (UE): Handover Request Ack” to the relay node RN #1 by way of the radio base station DeNB.

Here, it is not possible for the radio base station DeNB to recognize the “X2-AP (UE): Handover Request Ack”.

In step S3008A, the relay node RN #1 transmits an “RRC (UE): Handover Command” to the mobile station UE.

In step S3009A, the mobile station UE transmits an “RRC (UE): Handover Complete” to the relay node RN #2.

A “Path switch procedure” is performed between the relay node RN #2 and the gateway device SGW/PGW for the mobile station UE in step S3010A, and as a result, a downlink data signal is transferred to the relay node RN #2, other than the relay node RN #1, from the gateway device SGW/PGW for the mobile station UE.

In step S3011A, the relay node RN #2 transmits an “X2-AP (UE): UE Context release” to the relay node RN #1 by way of the radio base station DeNB.

### Mobile Communication System according to Fourth Embodiment of Present Invention

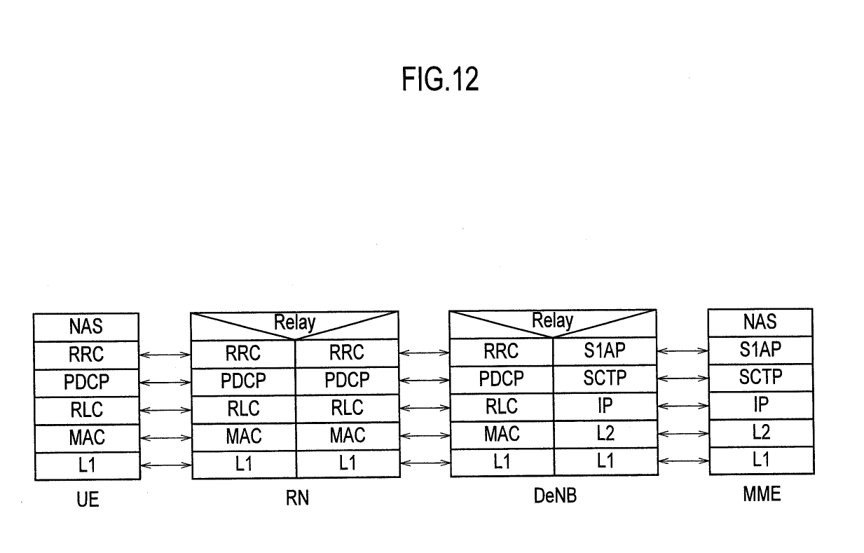

With reference to FIG. 12 to FIG. 14, a mobile communication system according to a fourth embodiment of the present invention will be described. Hereinafter, the mobile communication system according to the fourth embodiment of the present invention will be described while focusing on the difference from to the mobile communication system according to the above-mentioned second embodiment.

As illustrated in FIG. 12, the radio base station DeNB, as the function of a Un interface, includes the physical layer (L1) function, the MAC layer function, the RLC layer function, the PDCP layer function, and the RRC layer function.

The relay node RN, as the function of a Un interface, includes the physical layer (L1) function, the MAC layer function, the RLC layer function, the PDCP layer function, and the RRC layer function.

Furthermore, the RRC is configured to be terminated between the RRC layer function of the relay node RN and the RRC layer function of the radio base station DeNB.

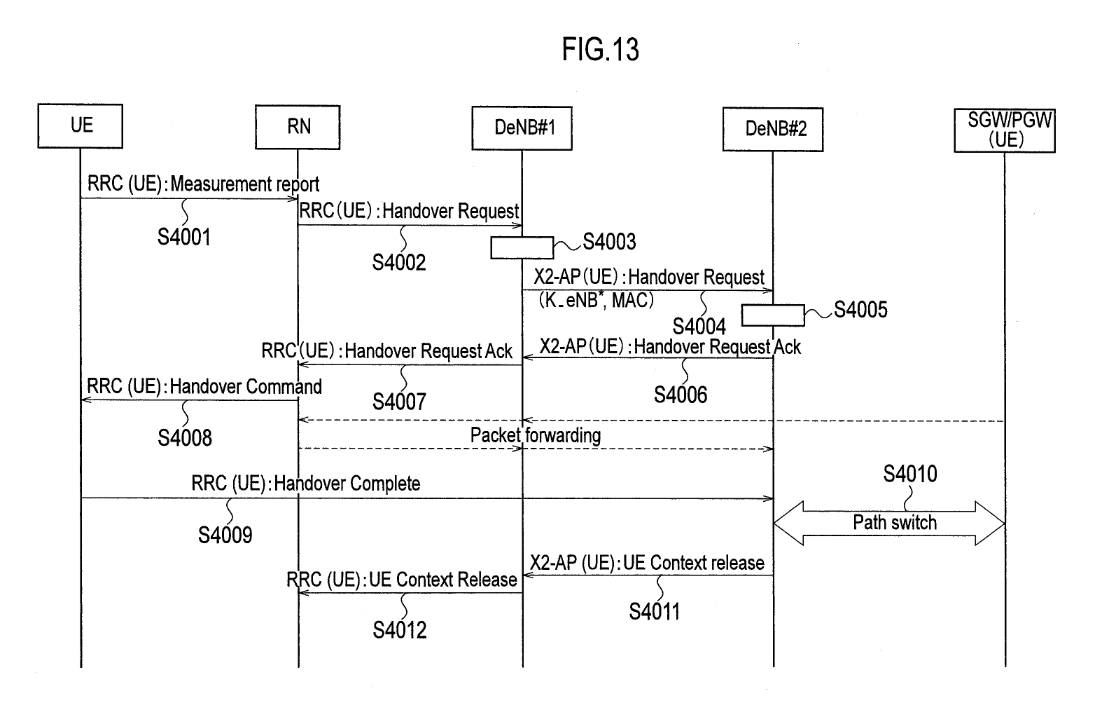

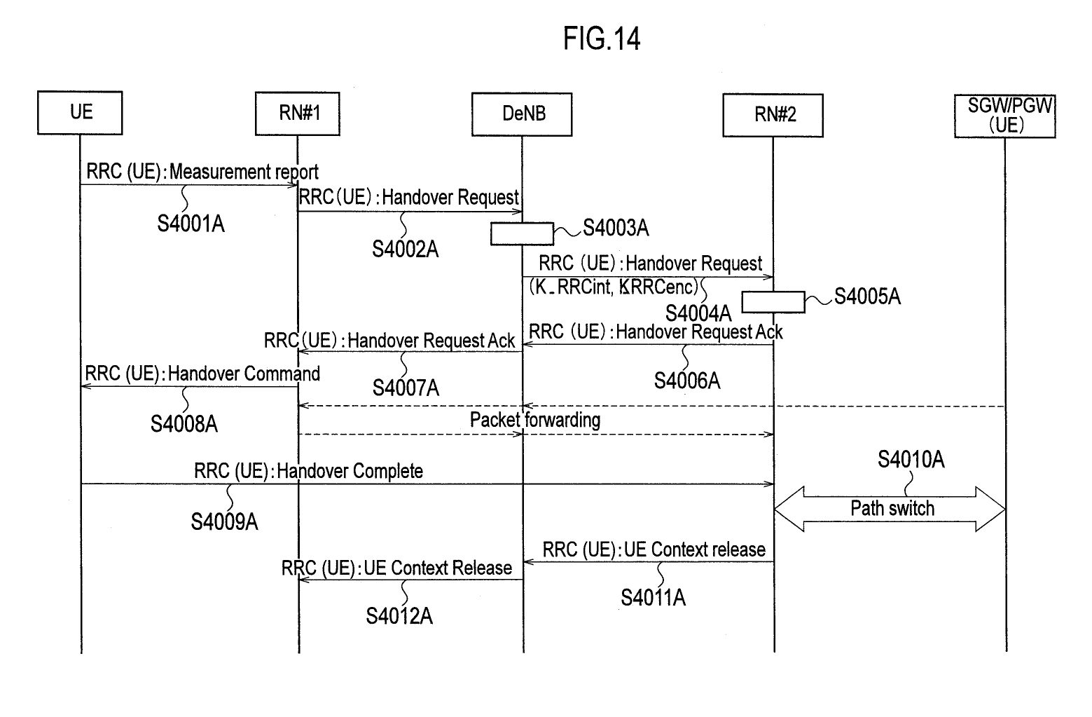

Hereinafter, with reference to FIG. 13 and FIG. 14, a handover method of the mobile station UE in the mobile communication system according to the present embodiment will be described.

Firstly, with reference to FIG. 13, the operation of the mobile communication system according to the present embodiment in the above-mentioned case 1 will be described.

As illustrated in FIG. 13, in step S4001, when predetermined conditions are satisfied, the mobile station UE transmits an “RRC (UE): Measurement report” to the relay node RN.

When it is determined to hand over the mobile station UE to the radio base station DeNB #2, the relay node RN transmits an “RRC (UE): Handover Request” to the radio base station DeNB #1 in step S4002.

The radio base station DeNB #1 extracts K_eNB* and MAC in response to the received “RRC (UE): Handover Request” in step S4003, and transmits an “X2-AP (UE): Handover Request” including the extracted K_eNB* and MAC to the radio base station DeNB #2 in step S4004.

In step S4005, the radio base station DeNB #2 generates KeNB based on the K_eNB* and the MAC included in the “X2-AP (UE): Handover Request”, and generates and holds the K_RRCint, the K_RRCenc, and the K_UPenc based on the KeNB.

In step S4006, the radio base station DeNB #2 transmits an “X2-AP (UE): Handover Request Ack” to the radio base station DeNB #1.

In step S4007, the radio base station DeNB #1 transmits an “RRC (UE): Handover Request Ack” to the relay node RN.

In step S4008, the relay node RN transmits an “RRC (UE): Handover Command” to the mobile station UE.

In step S4009, the mobile station UE transmits an “RRC (UE): Handover Complete” to the radio base station DeNB #2.

A “Path switch procedure” is performed between the radio base station DeNB #2 and a gateway device SGW/PGW for the mobile station UE in step S4010, and as a result, a downlink data signal is transferred to the radio base station DeNB #2, other than the relay node RN, from the gateway device SGW/PGW for the mobile station UE.

In step S4011, the radio base station DeNB #2 transmits an “X2-AP (UE): UE Context release” to the radio base station DeNB #1.

In step S4012, the radio base station DeNB #1 transmits an “RRC (UE): UE Context release” to the relay node RN.

Secondly, with reference to FIG. 14, the operation of the mobile communication system according to the present embodiment in the above-mentioned case 2 will be described.

As illustrated in FIG. 14, in step S4001A, when predetermined conditions are satisfied, the mobile station UE transmits an “RRC (UE): Measurement report” to the relay node RN #1.

When it is determined to hand over the mobile station UE to the relay node RN #2, the relay node RN #1 transmits an “RRC (UE): Handover Request” to the radio base station DeNB in step S4002A.

In step S4003A, the radio base station DeNB extracts K_eNB* and MAC in response to the received “RRC (UE): Handover Request”, generates K_eNB based on the K_eNB* and the MAC, and generates K_RRCint, K_RRCenc, and K_UPenc based on the KeNB.

In step S4004A, the radio base station DeNB transmits an “RRC (UE): Handover Request” including the generated K_RRCint and K_RRCenc and not including the generated K_UPenc to the relay node RN #2.

In step S4005A, the relay node RN #2 holds the K_RRCint and the K_RRCenc included in the “RRC (UE): Handover Request”.

In step S4006A, the relay node RN #2 transmits an “RRC (UE): Handover Request Ack” to the radio base station DeNB.

In step S4007A, the radio base station DeNB transmits the “RRC (UE): Handover Request Ack” to the relay node RN #1.

In step S4008A, the relay node RN #1 transmits an “RRC (UE): Handover Command” to the mobile station UE.

In step S4009A, the mobile station UE transmits an “RRC (UE): Handover Complete” to the relay node RN #2.

A “Path switch procedure” is performed between the relay node RN #2 and the gateway device SGW/PGW for the mobile station UE in step S4010A, and as a result, a downlink data signal is transferred to the relay node RN #2, other than the relay node RN #1, from the gateway device SGW/PGW for the mobile station UE.

In step S4011A, the relay node RN #2 transmits an “RRC (UE): UE Context release” to the radio base station DeNB.

In step S4012A, the radio base station DeNB transmits the “RRC (UE): UE Context release” to the relay node RN #1.

The characteristics of the present embodiment as described above may be expressed as follows:

A first characteristic of the present embodiment is summarized as a mobile communication method, more particularly, a handover method in which the mobile station UE is handed over to the radio base station DeNB #2 from the relay node RN connected to the radio base station DeNB #1, the method comprising: a step in which the relay node RN transmits the “RRC (UE): Handover Request” to the radio base station DeNB #1; a step in which the radio base station DeNB #1 allows the K_eNB* and the MAC to be included in the “X2-AP (UE): Handover Request” and transmits the “X2-AP (UE): Handover Request” to the radio base station DeNB #2; a step in which the radio base station DeNB #2 generates the KeNB based on the K_eNB* and the MAC included in the “X2-AP (UE): Handover Request”; and a step in which the radio base station DeNB #2 generates the K_RRCint, the K_RRCenc, and the K_UPenc based on the generated KeNB.

A second characteristic of the present embodiment is summarized as a mobile communication method, more particularly, a handover method in which the mobile station UE is handed over to the relay node RN #2 from the relay node RN #1 connected to the radio base station DeNB, the method comprising: a step in which the relay node RN #1 transmits the “RRC (UE): Handover Request” to the radio base station DeNB; a step in which the radio base station DeNB generates the KeNB based on the K_eNB* and the MAC in response to the “X2-AP (UE): Handover Request”; a step in which the radio base station DeNB generates the K_RRCint, the K_RRCenc, and the K_UPenc based on the generated KeNB; and a step in which the radio base station DeNB notifies the relay node RN #2 of only the generated K_RRCint and K_RRCenc.

A third characteristic of the present embodiment is summarized as, in a handover method in which the mobile station UE is handed over to the radio base station DeNB #2 from the relay node RN connected to the radio base station DeNB #1, a radio base station DeNB operating as the radio base station DeNB #2 comprising: a function configured to receive the “X2-AP (UE): Handover Request” from the radio base station DeNB #1 having received the “RRC (UE): Handover Request” from the relay node RN; a function configured to generate the KeNB based on the K_eNB* and the MAC included in the received “X2-AP (UE): Handover Request”; and a function configured to generate the K_RRCint, the K_RRCenc, and the K_UPenc based on the generated KeNB.

A fourth characteristic of the present embodiment is summarized as, in a handover method in which the mobile station UE is handed over to the relay node RN #2 from the relay node RN #1 connected to the radio base station DeNB, a radio base station DeNB comprising: a function configured to receive the “RRC (UE): Handover Request” from the relay node RN #1; a function configured to generate the KeNB based on the K_eNB* and the MAC in response to the received “X2-AP (UE): Handover Request”; a function configured to generate the K_RRCint, the K_RRCenc, and the K_UPenc based on the generated KeNB; and a function configured to notify the relay node RN #2 of only the generated K_RRCint and K_RRCenc.

It is noted that the operation of the above-described the radio base station DeNB, the relay node RN, the mobile station UE or the gateway device SGW/PGW may be implemented by a hardware, may also be implemented by a software module executed by a processor, and may further be implemented by the combination of the both.

The software module may be arranged in a storage medium of an arbitrary format such as RAM (Random Access Memory), a flash memory, ROM (Read Only Memory), EPROM (Erasable Programmable ROM), EEPROM (Electronically Erasable and Programmable ROM), a register, a hard disk, a removable disk, and CD-ROM.

The storage medium is connected to the processor so that the processor can write and read information into and from the storage medium. Such a storage medium may also be accumulated in the processor. The storage medium and processor may be arranged in ASIC. Such the ASIC may be arranged in the radio base station DeNB, the relay node RN, the mobile station UE or the gateway device SGW/PGW. Further, such a storage medium or a processor may be arranged, as a discrete component, in the radio base station DeNB, the relay node RN, the mobile station UE or the gateway device SGW/PGW.

Thus, the present invention has been explained in detail by using the above-described embodiments; however, it is obvious that for persons skilled in the art, the present invention is not limited to the embodiments explained herein. The present invention can be implemented as a corrected and modified mode without departing from the gist and the scope of the present invention defined by the claims. Therefore, the description of the specification is intended for explaining the example only and does not impose any limited meaning to the present invention.

1. A mobile communication method in which a mobile station is handed over to a second radio base station from a relay node connected to a first radio base station, the mobile communication method comprises:
a step in which the relay node transmits a handover request signal to the second radio base station;
a step in which the second radio base station acquires a first parameter and a second parameter from the first radio base station;
a step in which the second radio base station generates a master key based on the acquired first parameter and second parameter; and
a step in which the second radio base station generates a key for integrity inspection of a control signal, a key for encryption of a control signal, and a key for encryption of a data signal based on the generated master key.

2. A mobile communication method in which a mobile station is handed over to a second relay node from a first relay node connected to a radio base station, the mobile communication method comprises:
a step in which the first relay node transmits a handover request signal to the second relay node;
a step in which the second relay node transmits a security information request signal to the radio base station;
a step in which the radio base station generates a master key based on a first parameter and a second parameter in response to the security information request signal;
a step in which the radio base station generates a key for integrity inspection of a control signal, a key for encryption of a control signal, and a key for encryption of a data signal based on the generated master key; and
a step in which the radio base station notifies the second relay node of only the generated key for integrity inspection of a control signal and key for encryption of a control signal.

3. A mobile communication method in which a mobile station is handed over to a second radio base station from a relay node connected to a first radio base station, the mobile communication method comprises:
a step in which the relay node transmits a handover request signal to the first radio base station;
a step in which the first radio base station allows a first parameter and a second parameter to be included in the handover request signal, and transmits the handover request signal to the second radio base station;
a step in which the second radio base station generates a master key based on the first parameter and the second parameter included in the handover request signal; and
a step in which the second radio base station generates a key for integrity inspection of a control signal, a key for encryption of a control signal, and a key for encryption of a data signal based on the generated master key.

4. A mobile communication method in which a mobile station is handed over to a second relay node from a first relay node connected to a radio base station, the mobile communication method comprises:
a step in which the first relay node transmits a handover request signal to the radio base station;
a step in which the radio base station generates a master key based on a first parameter and a second parameter in response to the handover request signal;
a step in which the radio base station generates a key for integrity inspection of a control signal, a key for encryption of a control signal, and a key for encryption of a data signal based on the generated master key; and
a step in which the radio base station notifies the second relay node of only the generated key for integrity inspection of a control signal and key for encryption of a control signal.

5. In a handover method in which a mobile station is handed over to a second radio base station from a relay node connected to a first radio base station, a radio base station operating as the second radio base station comprising:
a function configured to receive a handover request signal from the relay node;
a function configured to acquire a first parameter and a second parameter from the first radio base station in response to the received handover request signal;
a function configured to generate a master key based on the acquired first parameter and second parameter; and
a function configured to generate a key for integrity inspection of a control signal, a key for encryption of a control signal, and a key for encryption of a data signal based on the generated master key.

6. In a handover method in which a mobile station is handed over to a second relay node from a first relay node connected to a radio base station, a radio base station operating as the radio base station comprising:
a function configured to receive a security information request signal from the second relay node having received a handover request signal from the first relay node;
a function configured to generate a master key based on a first parameter and a second parameter in response to the received security information request signal;
a function configured to generate a key for integrity inspection of a control signal, a key for encryption of a control signal, and a key for encryption of a data signal based on the generated master key; and
a function configured to notify the second relay node of only the generated key for integrity inspection of a control signal and key for encryption of a control signal.

7. In a handover method in which a mobile station is handed over to a second radio base station from a relay node connected to a first radio base station, a radio base station operating as the second radio base station comprising:
a function configured to receive a handover request signal from the first radio base station having received the handover request signal from the relay node;
a function configured to generate a master key based on a first parameter and a second parameter included in the received handover request signal; and
a function configured to generate a key for integrity inspection of a control signal, a key for encryption of a control signal, and a key for encryption of a data signal based on the generated master key.

8. In a handover method in which a mobile station is handed over to a second relay node from a first relay node connected to a radio base station, a radio base station operating as the radio base station comprising:
a function configured to receive a handover request signal from the first relay node;
a function configured to generate a master key based on a first parameter and a second parameter in response to the received handover request signal;
a function configured to generate a key for integrity inspection of a control signal, a key for encryption of a control signal, and a key for encryption of a data signal based on the generated master key; and
a function configured to notify the second relay node of only the generated key for integrity inspection of a control signal and key for encryption of a control signal.
